(19) United States
(12) Patent Application Publication
(10) Pub. No.: US 2025/0302234 A1
(43) Pub. Date: Oct. 2, 2025

(54) COOKING VESSEL

(71) Applicant: CHIH-HAO CHEN, KAOHSIUNG CITY (TW)

(72) Inventor: CHIH-HAO CHEN, KAOHSIUNG CITY (TW)

(21) Appl. No.: 18/616,375

(22) Filed: Mar. 26, 2024

(51) Int. Cl. A47J 37/10; A47J 37/01; A47J 43/20

(52) U.S. Cl. CPC A47J 37/10; A47J 37/01; A47J 43/20

(57) ABSTRACT

A cooking vessel has a vessel portion and a margin portion, and the vessel portion has at least one accommodating recess. The margin portion is connected to and surrounds the vessel portion, and the margin portion has multiple layers stacked together. Due to the margin portion, the cooking vessel has a solid edge and increases structural strength, such that the cooking vessel is hard to be deformed. Since the multiple layers of the margin portion closely stacked with each other, the margin portion is capable of resisting rust and preventing residues getting inside.

### BACKGROUND

### 1. Field of the Invention

The present invention relates to a cooking vessel, especially to a cooking vessel that has edge-folded structures to improve structural strength of the cooking vessel.

### 2. Description of the Prior Arts

A conventional cooking vessel such as cookware or bakeware has an extended margin portion which helps a user to hold the vessel. The extended margin portion extends outward and forms an outermost edge, and thus it is convenient for the user to pick up, and further allows the conventional cooking vessel to be placed on a rack via the extended margin portion.

However, the conventional cooking vessel is usually made of metal, and thus the structural strength of the extended margin portion may be insufficient to resist collision, such that the extended margin portion deforms easily even if there is only a slight hit on the conventional cooking vessel. Furthermore, the extended margin portion also expands a total surface area of the conventional cooking vessel, and thus the conventional cooking vessel is prone to rust. In addition, the edge of the extended margin portion may be sharp, such that the user may be hurt when touching the extended margin portion.

In addition, some conventional cooking vessels may have rolled or curled margin portions. The rolled or curled margin portion is hollow and has only one layer, and thus it is very limited for increasing structural strength of the rolled or curled margin portion. The rolled or curled margin portion is incapable of withstanding an impact as well. Besides, since the rolled or curled margin portion forms a hollow section on the cooking vessel, residues would easily get inside of the hollow section and cause microbes, which may lead to food contamination. The hollow section may also cause rusting issues over time.

To overcome the shortcomings, the present invention provides a cooking vessel to mitigate or obviate the aforementioned problems.

### SUMMARY

The main objective of the present invention is to provide a cooking vessel that has edge-folded structures to improve structural strength of the cooking vessel.

The cooking vessel has a vessel portion and a margin portion, and the vessel portion has at least one accommodating recess. The margin portion is connected to and surrounds the vessel portion, and the margin portion is folded downwardly multiple times such that it includes a first sheet portion, a second sheet portion, a third sheet portion, a fourth sheet portion, and a fifth sheet portion serially and integrally connected. The first sheet portion, the fifth sheet portion, the fourth sheet portion, and the third sheet portion are located from top to bottom, and the second sheet portion is located outermost of the margin portion and laterally covers the first sheet portion, the fifth sheet portion, the fourth sheet portion, and the third sheet portion. The first sheet portion is directly connected to the vessel portion and extends away from the vessel portion. The second sheet portion is directly connected to the first sheet portion and has a lateral surface facing outward and surrounding the vessel portion. The third sheet portion is directly connected to the second sheet portion and located below the first sheet portion. The fourth sheet portion is directly connected to the third sheet portion and located between the first sheet portion and the third sheet portion. A bottom surface of the fourth sheet portion contacts a top surface of the third sheet portion. The fifth sheet portion is directly connected to the fourth sheet portion and located between the first sheet portion and the fourth sheet portion. A top surface of the fifth sheet portion contacts a bottom surface of the first sheet portion, and a bottom surface of the fifth sheet portion contacts a top surface of the fourth sheet portion. The lateral surface of the second sheet portion is curved along a direction from the first sheet portion to the third sheet portion, and the lateral surface protrudes outwardly.

Due to the margin portion, the cooking vessel has a solid edge and increases structural strength, such that the cooking vessel is hard to be deformed. The margin portion is shaped smooth, and thus the user is safe to touch the margin portion. In addition, since the multiple layers of the margin portion are closely stacked with each other, the margin portion is capable of resisting rust and preventing residues getting inside, and thus food made with the cooking vessel would not be contaminated.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a cooking vessel in accordance with the present invention;

FIG. 2 is a side view of the cooking vessel in FIG. 1;

FIG. 3 is an enlarged and cross-sectional side view in partial section of the cooking vessel in FIG. 1;

FIGS. 4 to 6 are serial views demonstrating a process of folding a margin portion of the cooking vessel in FIG. 1;

FIG. 7 is a perspective view of a second embodiment of a cooking vessel in accordance with the present invention;

FIG. 8 is a side view of the cooking vessel in FIG. 7; and

FIG. 9 is an enlarged and cross-sectional side view of the cooking vessel in FIG. 7.

### DETAILED DESCRIPTION

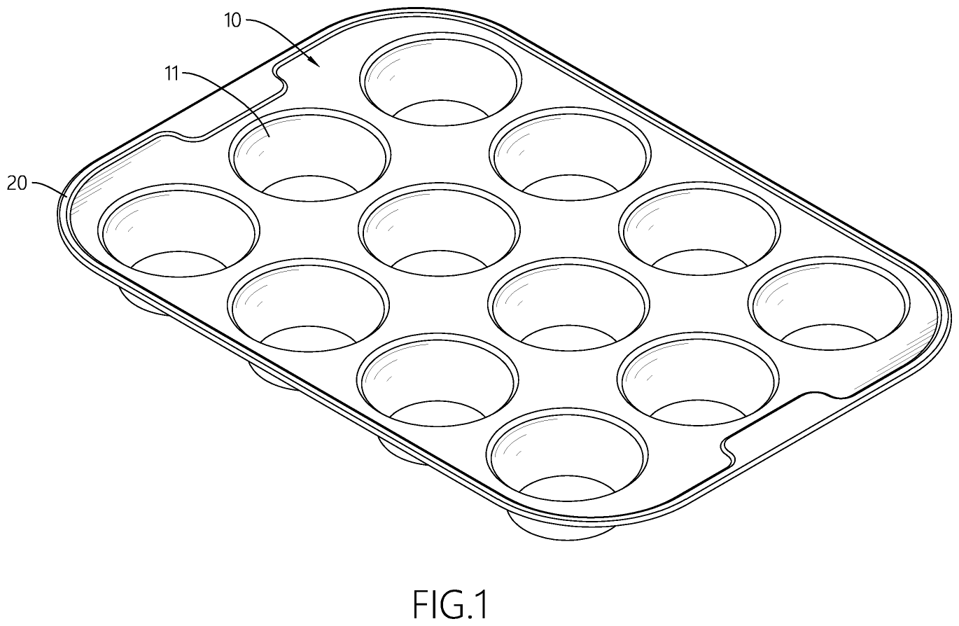

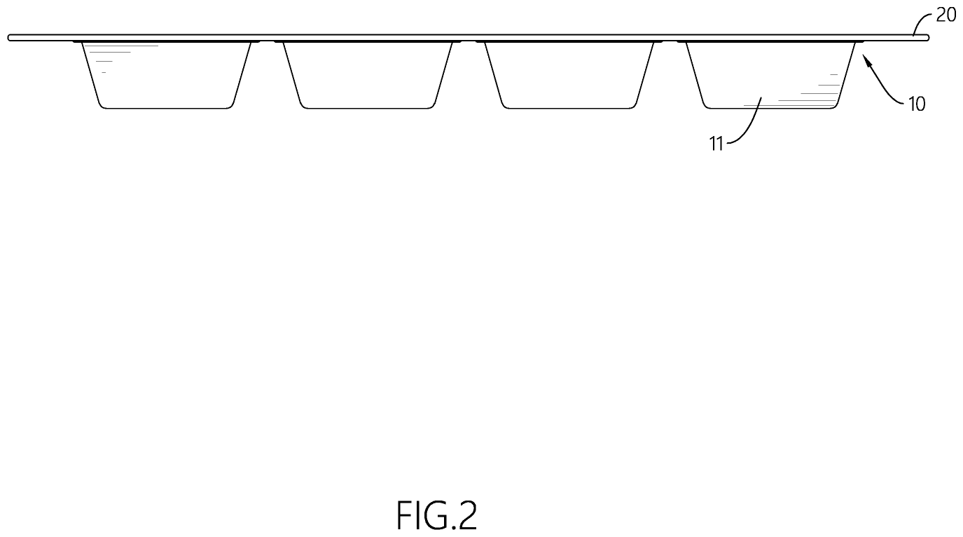

With reference to FIGS. 1 to 3, a first embodiment of a cooking vessel in accordance with the present invention comprises a vessel portion 10 and a margin portion 20 is illustrated.

The vessel portion 10 has at least one accommodating recess 11 and a connecting part 12. In the first embodiment, the vessel portion 10 has a plurality of the accommodating recesses 11 spaced at intervals, but it is not limited thereto. In another embodiment, the vessel portion 10 may have only one said accommodating recess 11. Each one of the accommodating recesses 11 is recessed downward from a top surface of the vessel portion 10.

The connecting part 12 surrounds the accommodating recesses 11, and the connecting part 12 is curved and obliquely extends upward. The vessel portion 10 is connected to the margin portion 20 via the connecting part 12, but it is not limited thereto. In another embodiment, the vessel portion 10 may not have the connecting part 12.

The margin portion 20 is connected to and surrounds the vessel portion 10. To be more precise, the margin portion 20 is connected to the connecting part 12 of the vessel portion 10. The margin portion 20 extends outward and is folded inward and downward. In the first embodiment, the margin portion 20 is double parallel folded, but it is not limited thereto.

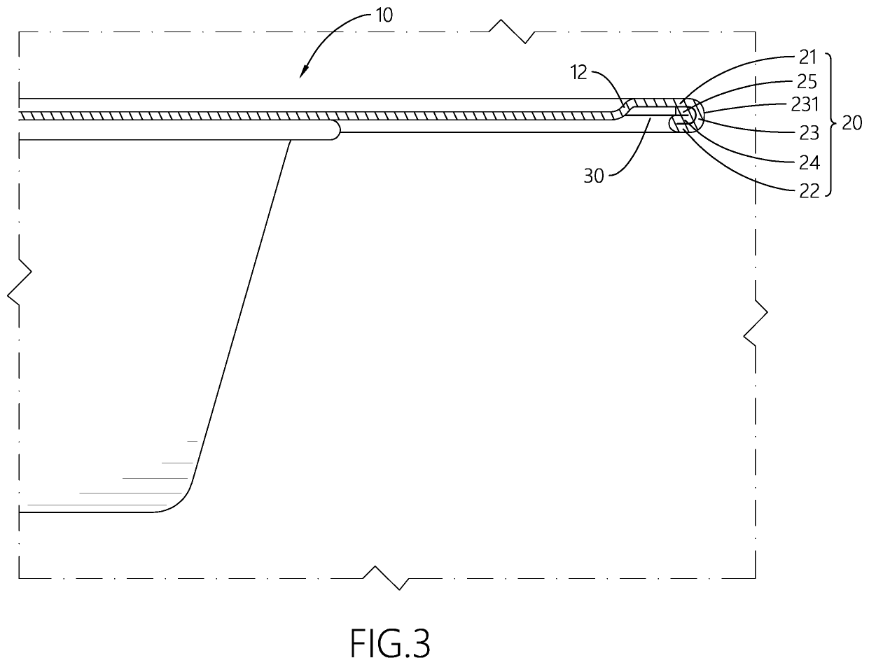

To be more precise, with reference to FIG. 3, the margin portion 20 has a first sheet portion 21, a third sheet portion 22, a second sheet portion 23, a fourth sheet portion 24, and a fifth sheet portion 25.

The first sheet portion 21 is connected to the vessel portion 10 and extends away from the vessel portion 10. In the first embodiment, the first sheet portion 21 is connected to the connecting part 12 of the vessel portion 10. The third sheet portion 22 is connected to and located below the first sheet portion 21.

The second sheet portion 23 connects with the first sheet portion 21 and the third sheet portion 22, and the second sheet portion 23 has a lateral surface 231 which faces outward and surrounds the vessel portion 10. The lateral surface 231 is curved along a direction from the first sheet portion 21 to the third sheet portion 22, and the lateral surface protrudes outwardly. It is not limited thereto, as a configuration of the second sheet portion 23 may be altered according to need.

The fourth sheet portion 24 is connected to the third sheet portion 22 and located between the first sheet portion 21 and the third sheet portion 22. A bottom surface of the fourth sheet portion 24 contacts a top surface of the third sheet portion 22.

The fifth sheet portion 25 is connected to the fourth sheet portion 24 and located between the first sheet portion 21 and the fourth sheet portion 24. A top surface of the fifth sheet portion 25 contacts a bottom surface of the first sheet portion 21, and a bottom surface of the fifth sheet portion 25 contacts a top surface of the fourth sheet portion 24.

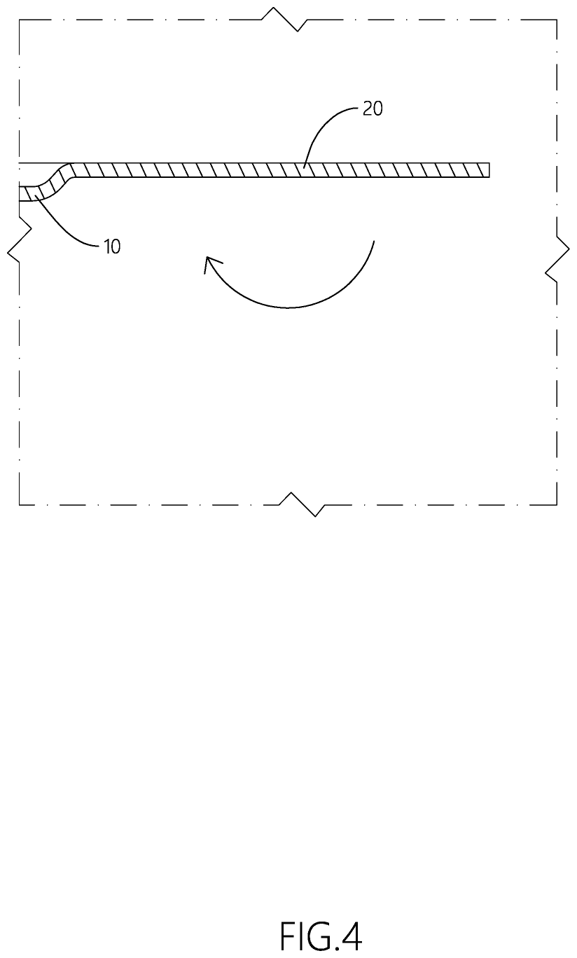

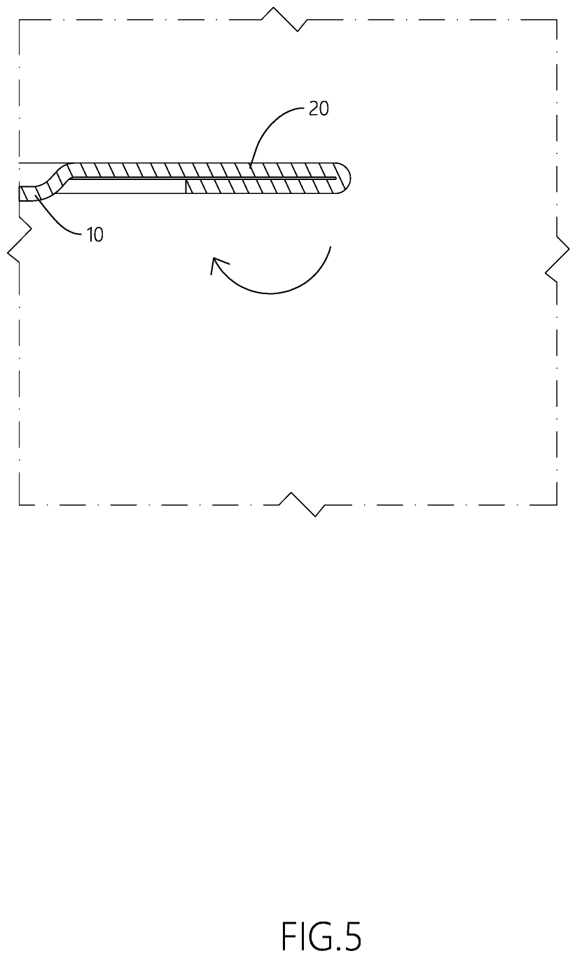

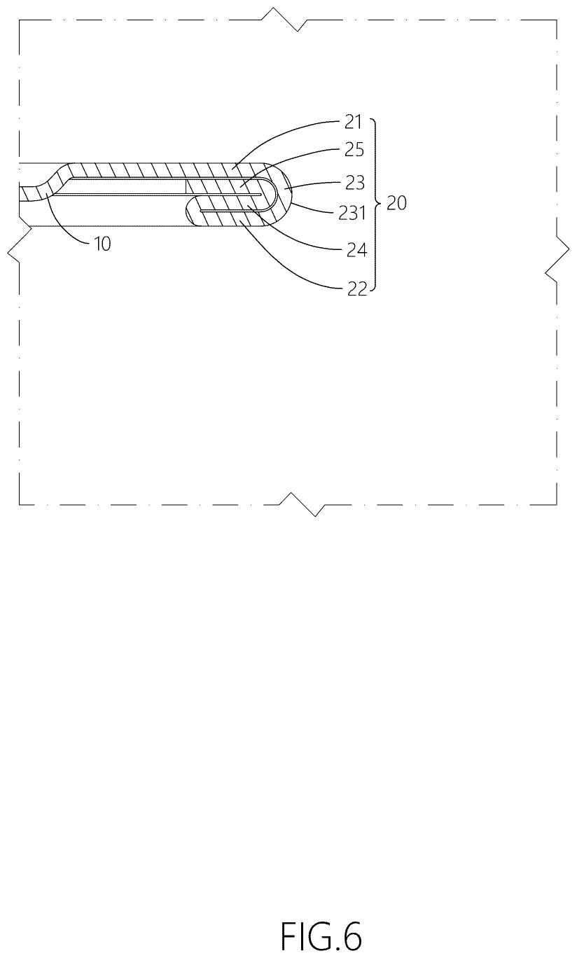

With reference to FIGS. 4 to 6, an exemplary process of folding the margin portion 20 is illustrated, but it is not limited thereto. The margin portion 20 is folded downward in half as shown in FIGS. 4 and 5. And then, with reference to FIG. 6, the margin portion 20 is folded downward in half again and forms a structure of the first sheet portion 21, the third sheet portion 22, the fourth sheet portion 24, and the fifth sheet portion 25 closely stacked together. From top to bottom of the structure are the first sheet portion 21, the fifth sheet portion 25, the fourth sheet portion 24, and the third sheet portion 22. In addition, the second sheet portion 23 is formed and located outermost of the margin portion 20, but it is not limited thereto, as the margin portion 20 may be folded in another way according to need.

In short, the margin portion 20 of the cooking vessel is double parallel folded, and thus has the structure of the first sheet portion 21, the third sheet portion 22, the fourth sheet portion 24, and the fifth sheet portion 25 closely stacked together. The margin portion 20 further has the lateral surface 231 located outermost and being smooth.

In addition, the margin portion 20 may be stretched before folding to obtain enough length to be folded, and thus a total thickness as well as a total volume of the margin portion 20 may be reduced, thereby consuming less material and reducing weight.

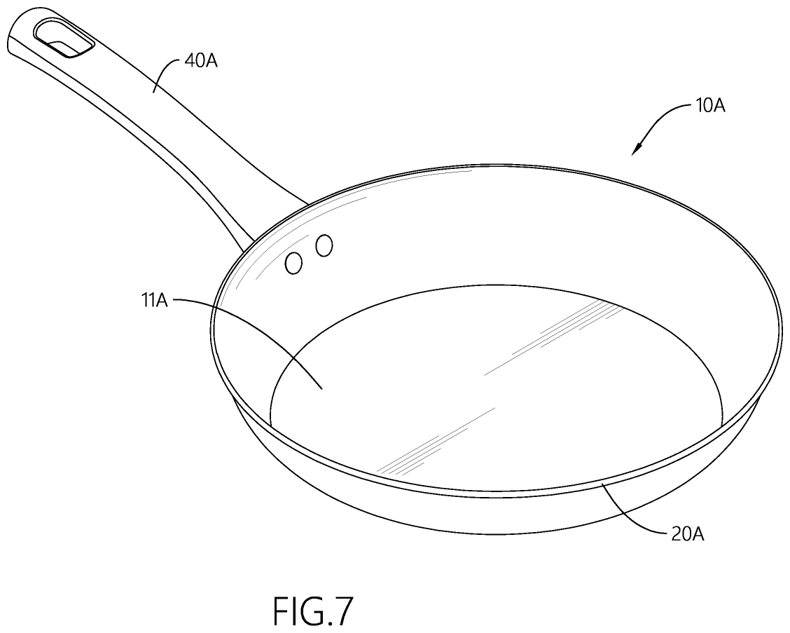

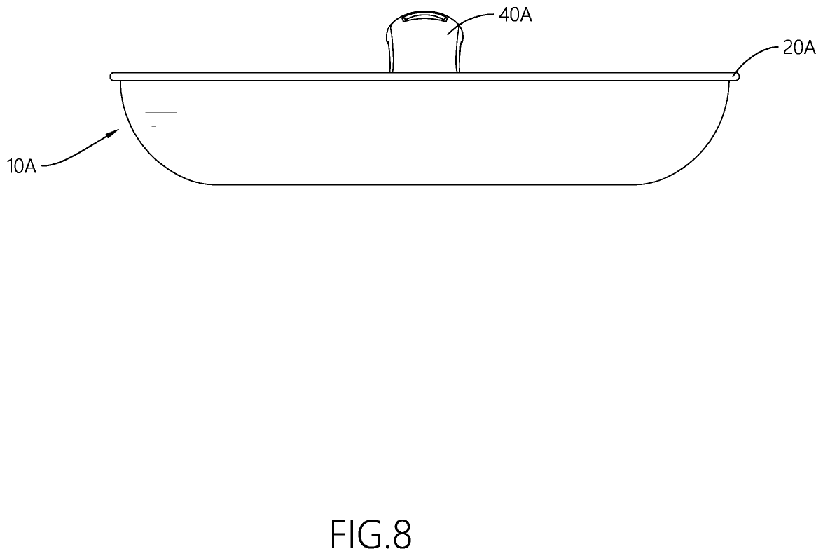

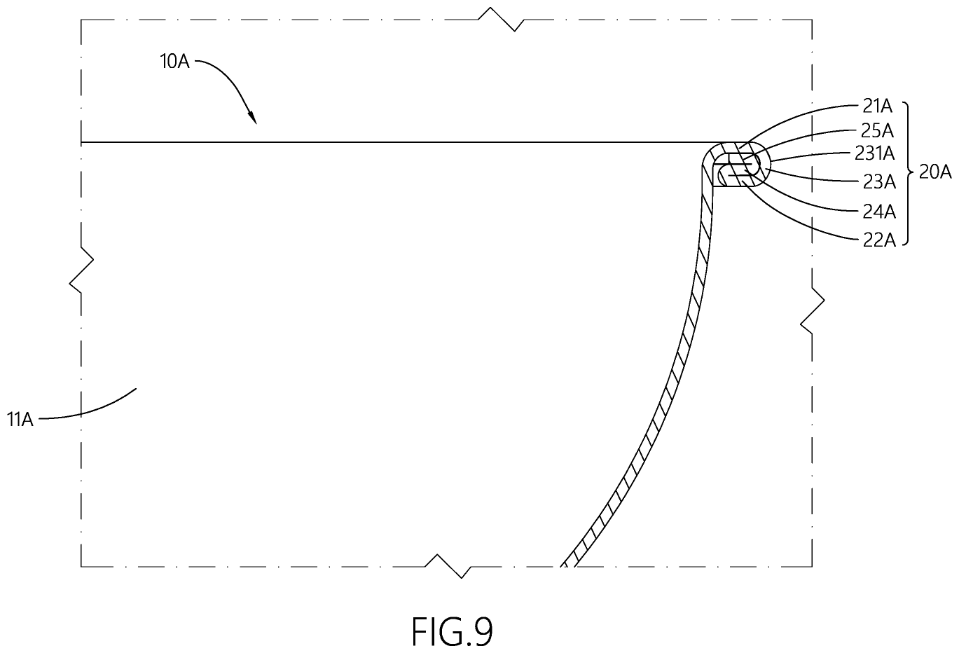

In the first embodiment, the cooking vessel is a mold, but it is not limited thereto, as the cooking vessel may be a fry pan as a second embodiment shown in FIGS. 7 to 9, a baking pan, a pot, or any other cookware and bakeware.

With reference to FIGS. 7 to 9, in the second embodiment, the vessel portion 10A has one said accommodating recess 11A, and the vessel portion 10A does not have the connecting part. The margin portion 20A is connected to the vessel portion 10A and surrounds the vessel portion 10A. In the second embodiment, the margin portion 20A is directly connected to the accommodating recess 11A. In addition, the second embodiment of the cooking vessel further has a handle 40A connected to the vessel portion 10A, but it is not limited thereto. The margin portion 20A may be folded under a process similar to that demonstrated in FIGS. 4 to 6, but it is not limited thereto.

Due to the margin portion 20, 20A, the cooking vessel has a solid edge and increases structural strength, such that the cooking vessel is hard to be deformed. The lateral surface 231, 231A of the second sheet portion 23, 23A is curved along the direction from the first sheet portion 21, 21A to the third sheet portion 22, 22A, and the lateral surface 231, 231A protrudes outwardly, such that the margin portion 20, 20A is shaped smooth instead of being sharp, and thus the user is safe to touch the margin portion 20, 20A.

In addition, since the margin portion 20, 20A has the first sheet portion 21, 21A, the third sheet portion 22, 22A, the fourth sheet portion 24, 24A, and the fifth sheet portion 25, 25A closely stacked together, the margin portion 20, 20A is capable of resisting rust and preventing residues getting inside, and thus food made with the cooking vessel would not be contaminated. Furthermore, the margin portion 20, 20A may be stretched before folding, and thus the cooking vessel has less material usage and is better for the environment.

Moreover, as shown in FIG. 3, due to the connecting part 12 obliquely extending upward and connecting with the margin portion 20, a groove 30 is formed between the connecting part 12 and the margin portion 20, and thereby a rack is capable of stably supporting on the groove 30 to hold the cooking vessel. Besides, the connecting part 12 and the margin portion 20 together form a structure for the user to pinch, and thereby the user is easy to hold the cooking vessel.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A cooking vessel comprising:
a vessel portion having at least one accommodating recess; and
a margin portion connected to and surrounding the vessel portion, and the margin portion folded downwardly multiple times such that the margin portion includes a first sheet portion, a second sheet portion, a third sheet portion, a fourth sheet portion, and a fifth sheet portion serially and integrally connected,
the first sheet portion, the fifth sheet portion, the fourth sheet portion, and the third sheet portion being located from top to bottom,
the second sheet portion being located outermost of the margin portion and laterally covering the first sheet portion, the fifth sheet portion, the fourth sheet portion, and the third sheet portion,
the first sheet portion being directly connected to the vessel portion and extending away from the vessel portion,
the second sheet portion being directly connected to the first sheet portion and having a lateral surface facing outward and surrounding the vessel portion,
the third sheet portion being directly connected to the second sheet portion and located below the first sheet portion,
the fourth sheet portion being directly connected to the third sheet portion and located between the first sheet portion and the third sheet portion, a bottom surface of the fourth sheet portion contacting a top surface of the third sheet portion,
the fifth sheet portion being directly connected to the fourth sheet portion and located between the first sheet portion and the fourth sheet portion, a top surface of the fifth sheet portion contacting a bottom surface of the first sheet portion, and a bottom surface of the fifth sheet portion contacting a top surface of the fourth sheet portion,
wherein the lateral surface of the second sheet portion is curved along a direction from the first sheet portion to the third sheet portion, and the lateral surface protrudes outwardly.

2. (canceled)

3. (canceled)

4. The cooking vessel as claimed in claim 1, wherein the vessel portion has a plurality of accommodating recesses, and the plurality of accommodating recesses are arranged spaced apart from each other.

5. (canceled)

6. The cooking vessel as claimed in claim 1, wherein:
the vessel portion has a connecting part surrounding the at least one accommodating recess, the connecting part being curved and obliquely extending upward; and
the vessel portion is connected to the margin portion via the connecting part.

7. The cooking vessel as claimed in claim 4, wherein:
the vessel portion further has a connecting part surrounding the accommodating recesses, the connecting part being curved and obliquely extending upward; and
the vessel portion is connected to the margin portion via the connecting part.

8. (canceled)

9. (canceled)
